(19) United States
(12) Patent Application Publication
(10) Pub. No.: US 2011/0116206 A1
(43) Pub. Date: May 19, 2011

(54) COOLING OF ELECTRONIC COMPONENTS USING SELF-PROPELLED IONIC WIND

(75) Inventor: Young Han KIM, Koyang-si (KR)

(73) Assignee: MENTORNICS, INC., Seoul (KR)

(21) Appl. No.: 12/619,516

(22) Filed: Nov. 16, 2009

(51) Int. Cl. H01T 23/00

(52) U.S. Cl. 361/231

(57) ABSTRACT

An ionic wind generator that ionizes air particles by multiple pins connected to a positive voltage source, and accelerating the ionized air particles and surrounding non-ionized air particles towards a heat sink attached to a heat source such as a semiconductor chip. A pin assembly of the ionic wind generator includes a substrate and multiple pins secured thereto. The pin assembly has passages or perforations that allow air to flow into the ionic wind generator in a longitudinal direction of the pin to reduce resistance from the multiple pins. A heat sink is connected to a low voltage source or ground to attract the ionized air particles. The ionized air particles impinge on the surface of the heat sink and cool the heat sink. An ion lens may also be disposed between the substrate and the heat sink to accelerate the ionized air particles to a higher speed. The ionic wind generator is capable of dissipating heat effectively, and obviates the need for a fan to force the air to the heat sink.

### BACKGROUND

This invention relates to cooling a heat source by ionizing air particles and directing the ionizing particles to the heat source or a heat sink thermally coupled to the heat source.

As semiconductor chips become more powerful and crowded with components, more heat is generated during their operations. For example, semiconductor chips such as microprocessors, digital signal processors (DSPs), graphics processing unit (GPU) and power handling semiconductors generate a large amount of heat during their operations. If heat generated by these semiconductor chip is not effectively dissipated from the semiconductor chips, excessive heat will accumulate in the semiconductors and cause various issues such as damages or degradation of the semiconductor chips, reduced lifespan of the semiconductor chips, and causing of toxic gas or fire.

Conventional heat dissipation mechanisms include heat sinks, air fans and liquid cooling systems. A heat sink usually consists of a metal structure with one or more flat surfaces to ensure good thermal contact with the components to be cooled, and an array of comb or fin like protrusions to increase the surface contact with the air and the rate of heat dissipation. The heat sink is sometimes used in conjunction with a fan to increase the rate of airflow over the heat sink. The fan helps generate a larger temperature gradient by replacing warmed air faster than by convection alone. The use of fan to increase the airflow is known as a forced air system. Although the fan increases the amount of heat dissipated, high acoustic noise levels often become an issue.

Liquid cooling system uses circulating liquid to cool electronic components. The liquid cooling system is comprised of a liquid block, a pump and a heat exchanger (e.g., radiator). The liquid block is attached to a heat source to absorb heat from the electronic components. The pump circulates liquid between the liquid block and the heat exchanger. The heat exchanger cools the heated liquid so that the cooled liquid can be circulated to the liquid block. Although such as liquid cooling is more effective in removing a large amount of heat from the electronic components, the liquid cooling system is expensive to implement and excessively large to be accommodated in a small electronic device.

### SUMMARY

Embodiments of the invention relate to an ionic wind generator for cooling a heat source by generating ionic wind and directing the ionic wind to a collector electrode thermally coupled to a heat source. The ionized wind generator includes an electrode assembly and the collector electrode. The electrode assembly includes a plurality of ionizing electrodes coupled to a positive voltage source to ionize surrounding air particles. Passages are formed in the electrode assembly to direct air flow into the ionized wind generator. The collector electrode is placed between the electrode assembly and the heat source. The collector electrode receives heat from the heat source and attracts the ionized air particles by connecting to a low voltage source. The ionized air particles impinge on the collector electrode and facilitate dissipation of heat from the collector electrode and the heat source.

In one embodiment, the electrode assembly comprises a substrate having a plurality of perforations. The ionizing electrodes are secured to the substrate. At least some of the ionizing electrodes are located adjacent to the perforations. By locating the electrodes adjacent to the perforations, external air is constantly provided to the electrodes for ionization and prevents pressure from dropping within the ionized wind generator.

In one embodiment, air flows into the ionized wind generator via the perforations in a direction that is substantially parallel to the lengths of the ionizing electrodes. By directing air flow in this manner, the ionizing electrodes do not impede the air flow caused by ionized the air particles.

In one embodiment, the ionic wind generator further includes an ion lens placed between the electrode assembly and the collector electrode. The ion lens is coupled to a negative voltage source to accelerate the ionized air particles towards the collector electrode. The ion lens may include a frame and a plurality of wires wound around the frame and/or spot welded to the frame. The wires of the ion lens may be formed of tungsten.

In one embodiment, the electrodes are formed of platinum, rhodium, tungsten or stainless steel.

### BRIEF DESCRIPTION OF THE DRAWINGS

FIG. 1 is an exploded perspective view of an ionic wind generator, according to one embodiment.

FIG. 2 is a sectional view of the ionic wind generator of FIG. 1, according to one embodiment.

FIG. 3A is a plan view of a pin assembly in an ionic wind generator, according to one embodiment.

FIG. 3B is a sectional view of the pin assembly in FIG. 3A, according to one embodiment.

FIG. 3C is a diagram illustrating a pin in the pin assembly of FIG. 3A, according to one embodiment.

FIG. 4A is a plan view of an ion lens in the ionic wind generator of FIG. 1, according to one embodiment.

FIG. 4B is a sectional view of the ion lens of FIG. 4A, according to one embodiment.

FIG. 5 is a sectional view of an ionic wind generator, according to another embodiment.

FIG. 6 is a flowchart illustrating a process of generating ionic wind, according to one embodiment.

### DETAILED DESCRIPTION

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown, but is to be accorded the widest scope consistent with the principles and features disclosed herein.

Embodiments relate to an ionic wind generator that ionizes air particles by multiple ionizing electrodes connected to a positive voltage source, and accelerating the ionized air particles and surrounding air particles towards a collector electrode thermally coupled to a heat source (e.g., a semiconductor chip). An electrode assembly of the ionic wind generator includes a substrate and multiple ionizing electrodes secured thereto. The electrode assembly has passages or perforations that allow external air to flow into the ionic wind generator in the longitudinal direction of the multiple electrodes. The collector electrode may be a heat sink connected to a negative voltage source or ground to attract the ionized air particles. The ionized air particles impinge on the surface of the collector electrode and cool the collector electrode. An ion lens may also be placed between the substrate and the heat sink to accelerate the ionized air particles to a higher speed before impinging on the surface of the collector electrode. The ionic wind generator is capable of dissipating heat effectively, and obviates the need for a fan to force air to a heat sink.

### Electro Hydro Dynamics and Design Considerations

Electro Hydro Dynamics (EHD) refers to the study of the flow of a fluid under the effect of an electric field. After fluid particles are electrically charged, the fluid particles respond to electric fields. Using this principle, electrically charged air particles may be propelled by electric fields to create air flow. As the charged air particles are accelerated, non-charged air particles are dragged along with the charged air particles by sheer force, caused by viscosity of the air. The charged air particles together with the dragged non-charged air particles create a net air flow (hereinafter referred to as the “ionic wind”). An ionic wind generator herein refers to a device that uses the principle of EHD to generate ionic wind.

The ionic wind created by the ionized air particles may be used to cool heat sources such as a semiconductor chip. The ionic wind is effective in dissipating the heat from a collector electrode. Although the principle is not completely understood at this time, the ionic wind is more effective in dissipating heat compared to non-ionic wind. As described, for example, in Prachi Patel, “Cooling Chips with an Ion Breeze,” Technology Review Published by MIT (Aug. 22, 2007), adding ionized air particles to wind induced by a fan caused a semiconductor chip to cool down to a lower temperature compared to forcing air by the fan alone without ionized air particles.

To generate ionic wind, two types of electrodes are needed. One is an ionizing electrode connected to a positive voltage source for ionizing air particles. The ionizing electrode strips electrons from molecules of gases (e.g., oxygen and nitrogen), and ionizes these gas molecules to positively charged ions. The ionizing electrode can be of various configurations. In one embodiment, the ionizing electrode includes an electrode tip to facilitate ionization of air particles.

The other type of electrode needed is a collector electrode. The collector electrode is connected to a negative voltage source or ground. The collector electrode in conjunction with the ionizing electrode forms an electric field that attracts the ionized air particles. In one embodiment, the collector electrode is a heat sink thermally coupled to a heat source to absorb heat from the heat source.

The strength and speed of ionic wind is governed by various factors including, among others, the following: (i) the voltage of the ionizing electrode, (ii) the voltage of the collector electrode, (iii) materials used for the ionizing electrode, (iv) the number and configuration of ionizing electrodes, (v) presence of any structures obstructing air flow, (vi) the rate of replenishing uncharged air particles to the ionizing electrode, and (vii) the distance between the ionizing electrode and the collector electrode. As described hereinafter, these factors may be limited by practical considerations and limitations.

From the perspective of generating a stronger ionic wind, it is advantageous to raise the voltage of the ionizing electrode because a higher voltage at the ionizing electrode tends to generate more ionized air particles. Further, lowering the voltage of the collector electrode tends to increase the strength of the ionic wind because a stronger electric field is formed between the ionizing electrode and the collector electrode, causing the ionized particles to accelerate at a higher rate. However, as the voltage difference between the voltage of the ionizing electrode and the voltage of the collector electrode increases, sparks are more likely to occur between the ionizing electrode and the collector electrode. The spark may interfere with the operation of nearby electronic components, and thus, the spark should be avoided.

Materials used as ionizing electrodes affect the amount of air particles ionized. Materials such as platinum, rhodium, tungsten and stainless steel exhibit good performance in ionizing air particles. Metals such as platinum and rhodium are, however, very expensive and hence, raise the overall cost of the ionizing wind generator.

The number of ionizing electrodes also affects the strength and speed of the ionic wind. A single electrode pin may produce a small amount of ionized air particles insufficient to generate strong ionic wind. Hence, a plurality of ionizing electrodes may be deployed to increase the amount of ionized air particles generated. Absent careful design, however, a large number of electrodes will impede the air flow generated by the ionized air particles, reducing the strength and speed of the ionic wind.

Further, once air particles are ionized and move toward the collector electrode, low pressure or a temporary vacuum state arises at the place where the air particles previously resided. In order to increase the rate of generating the electrodes, a fresh supply of uncharged air must be constantly provided to the ionizing electrodes. If the supply of uncharged air is insufficient, the rate at which the air particles are ionized will decrease, resulting in overall reduction in the speed of the ionic wind.

The distance between the ionizing electrode and the collector electrode also plays a role in the strength and speed of the ionic wind. The closer the distance between the ionizing electrode and the collector electrode, the stronger the air flow tends to become because the electric field between the electrodes are stronger and a larger portion of the ionized air particles become attracted to the collector electrode without being diverted elsewhere. The voltage difference between the ionizing electrode and the collector electrode sufficient to cause an ionic wind is closely correlated with the distance between the ionizing electrode and the collector electrode. At 10 to 15 mm distance between the ionizing electrode and the collector electrode, the voltage difference for generating the air flow is about 10 kV to 11 kV. It is advantageous to decrease the distance between the ionizing electrodes and the collector electrode from the perspective of increasing the speed and strength of ionic wind. However, the decreased distance also increases the likelihood of sparks occurring between the ionizing electrode and the collector electrode, and therefore, serves as a factor limiting the distance between the electrodes.

In order to design a cooling device that uses EHD, above design considerations and limitations must be carefully contemplated, especially when designing a cooling device that does not require a fan or other mechanical devices to pump air flow onto a heat source.

### Example Embodiments of Ion Wind Generator

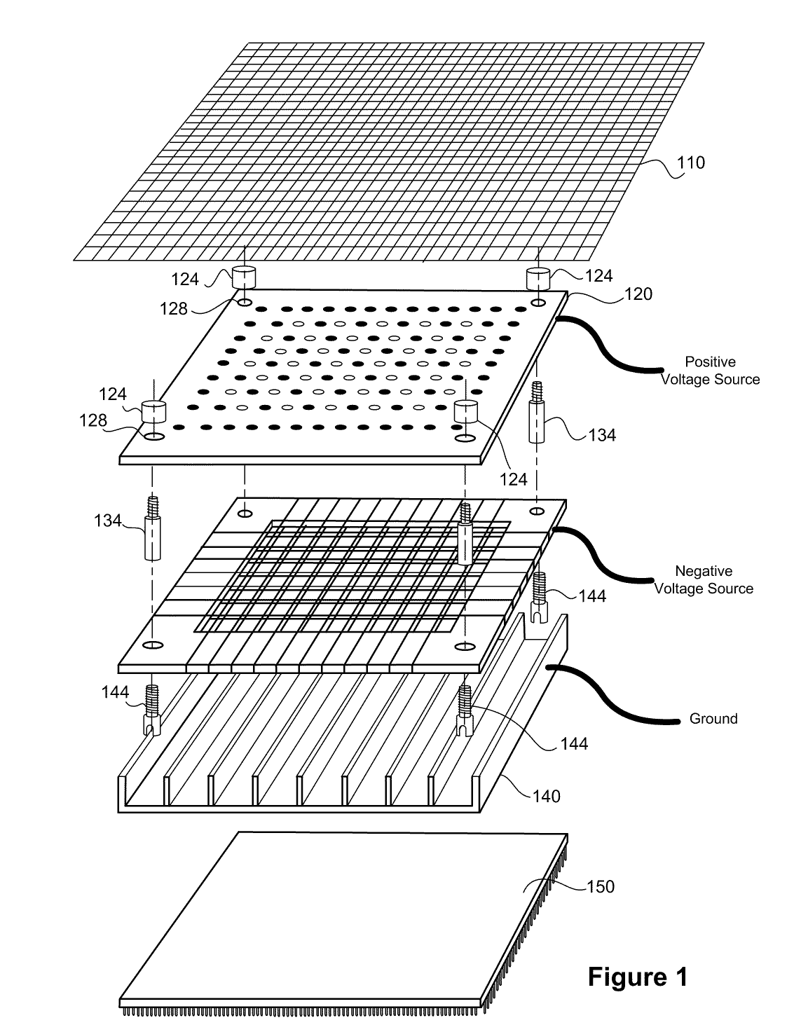

FIG. 1 is an exploded perspective view of an ionic wind generator 100, according to one embodiment. The ionic wind generator 100 may include, among other components, a metal mesh 110, a pin assembly 120, an ion lens 130 and a heat sink 140. The metal mesh 110 is formed of a conductive material that covers the entire ionic wind generator 100 or part of the ionic wind generator 100. The heat sink 140 is thermally coupled to a semiconductor chip 150 to absorb heat from the semiconductor chip 150. A layer of material such as thermal compound may be placed between the heat sink 140 and the semiconductor chip 150 to enhance thermal conductivity while electrically insulating the semiconductor chip 150 from the ionic wind generator 100. The ionic wind generator 100 dissipates heat absorbed by the heat sink 140.

The metal mesh 110 reduces the amount of ionized air particles of the ionic wind leaving the ionic wind generator 100. One consideration in using the ionic wind is that a large amount of positively charged air particles may interfere or disrupt the operation of electronic components or signal lines exposed to the ionized air particles. Hence, a measure may be needed to prevent an excessive amount of the ionized air particles from coming into contact and interacting with electronic components or signal lines carrying current. The metal mesh 110 is connected to ground and functions to neutralize any ionized air particles that come into contact. The wires in the metal mesh 110 may be closely packed with each other to neutralize sufficient amount of ionized air particles but not too closely packed to significantly impede air flow into or out of the ionic wind generator 100. The metal mesh 110 also prevents dust or other contaminants from accumulating in the holes or on electrodes of the pin assembly 120.

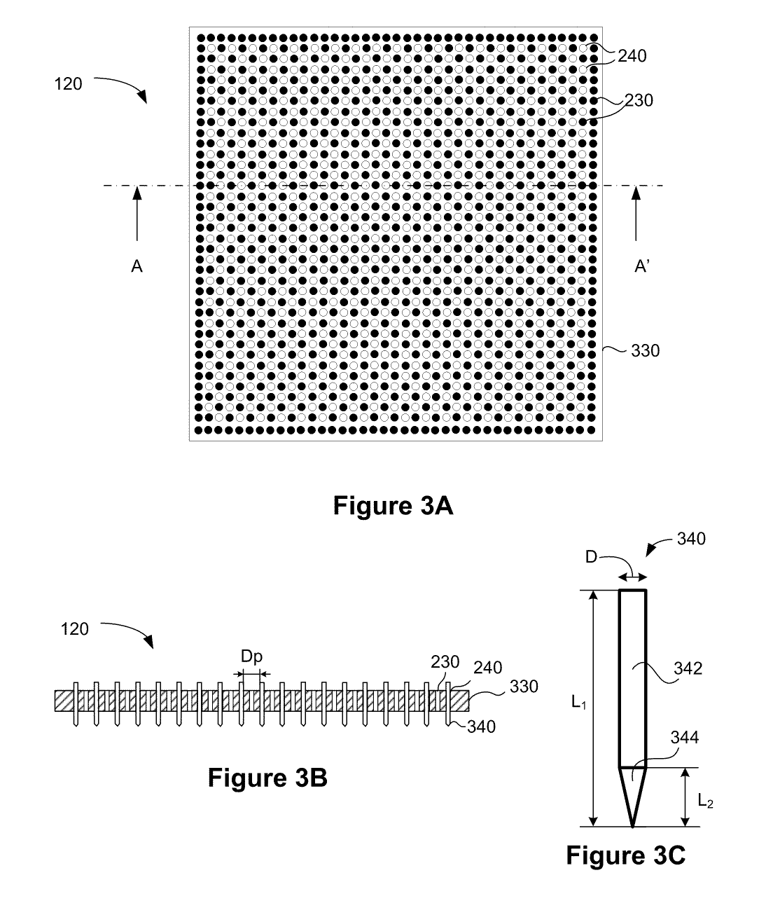

The pin assembly 120 includes a substrate and ionizing electrode pins mounted on the pin assembly, as described below in detail with reference to FIG. 3A. The ionizing electrode pins in the pin assembly 120 are connected to a positive voltage source to ionize surrounding air particles. Multiple perforations are formed on the substrate to allow air to flow into the ionic wind generator 100. The pin assembly 120 is placed above the ion lens 130, separated by a set of non-conductive spacers 134.

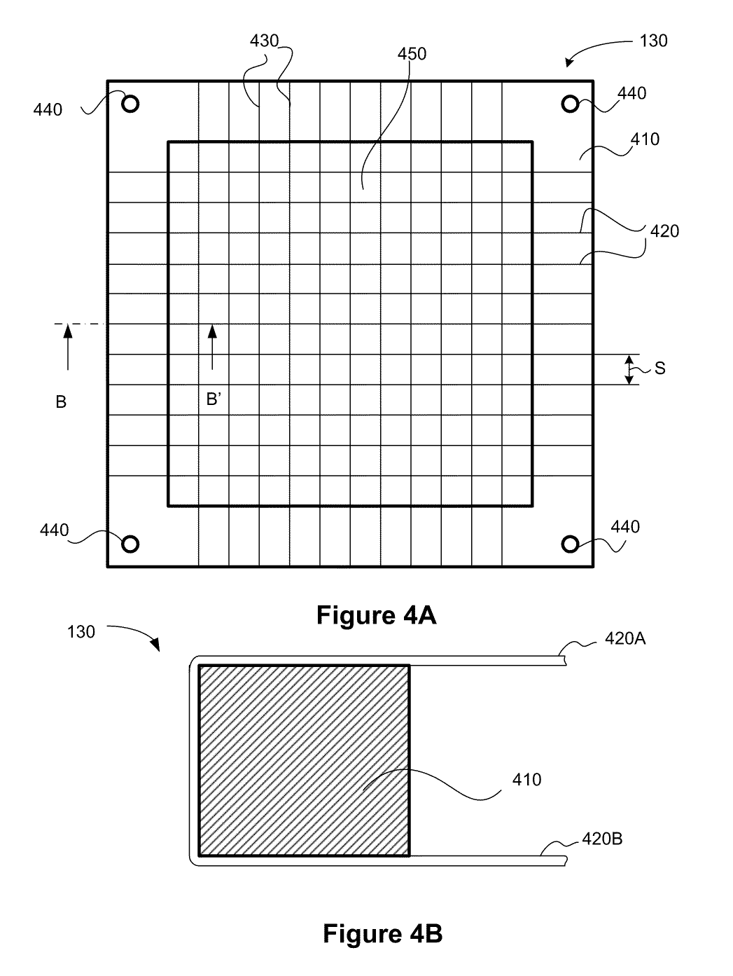

The ion lens 130 includes a metal frame and threads of wires wound around the metal frame, as described below in detail with reference to FIG. 4A. The ion lens 130 is connected to a negative voltage source. The ion lens 130 generates a magnetic field within the ionic wind generator 100 to accelerate ionized air particles toward the heat sink 140. The ion lens 130 is placed above the heat sink 140, separated by a set of non-conductive holders 144. In one embodiment, the wires may be spot welded to the metal frame.

In one embodiment, the substrate of the pin assembly 120 has through-holes 128 at its four corners. The spacers 134 have end portions with screw threads formed thereon. In one embodiment, the spacers 134 are formed of plastic. The end portions of the spacers 134 are inserted into the through-holes 128 and secured by caps 124. Similarly, the ion lens 130 has through-holes at its four corners. End portions of the holders 144 have screw threads formed thereon. The end portions of the holders 144 are inserted into the ion lens 130. The spacers 134 have holes (not shown) at their bottom portions to receive the end portions of the holders 144. In one embodiment, the holders 144 are formed of plastic. The spacers 134 and the holders 144 support the pin assembly 120 and the ion lens 130, respectively.

The heat sink 140 functions as a collector electrode. The heat sink 140 is placed on the top surface of the semiconductor chip 150. A layer of thermal compound may be placed between the bottom surface of the heat sink 140 and the top surface of the semiconductor chip 150. The thermal compound electrically insulates the semiconductor chip 150 from any electrical interference that may originate from the ionic wind generator 100 as well as increasing the heat transfer from the semiconductor chip 150 to the heat sink 140. The heat sink 140 is also coupled to ground so that any ionized particles impinging on the heat sink 140 are electrically neutralized.

The difference between the positive voltage and the negative voltage may be set according to various parameters and configurations of the ionic wind generator 100. The voltage difference between the positive voltage and the negative voltage may be as low as several kilovolts and as high as tens of kilovolts. Higher voltage difference may also be used.

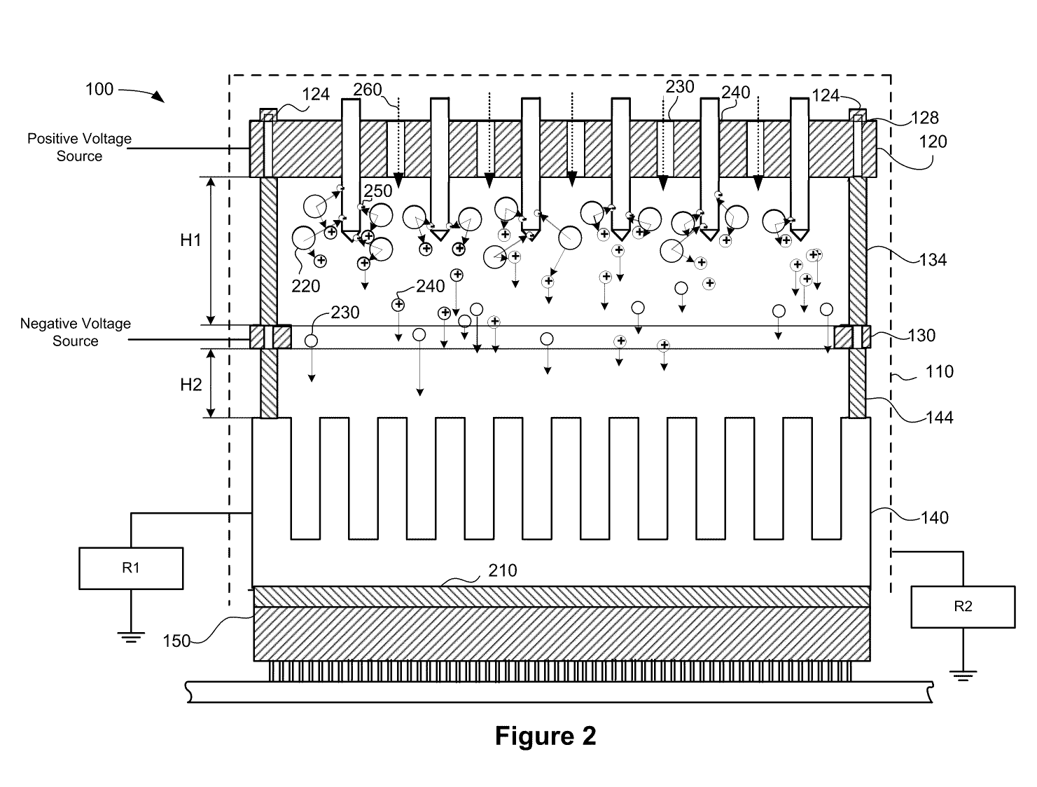

FIG. 2 is a sectional view of the ionic wind generator of FIG. 1, according to one embodiment. The ionizing electrode pins of the pin assembly 120 strip electrons 250 (shown as small circles with minus signs) from air molecules 220 (shown as large circles without any signs) and generate ionized air particles 240 (shown as circles with plus signs). The ionized air particles 240 are attracted and accelerated by the ion lens 130. Although a small fraction of the ionized air particles collide with the ion lens 130 and become neutralized, a majority of the ionized air particles passes the ion lens 130 and impinge on the heat sink 140. The accelerated ionized air particles 240 also drag electrically neutral air particles 230 (shown as small circles without any signs) and create a net flow of air toward the heat sink 140.

As the ionized air particles 240 and surrounding neutral air particles 230 move towards the heat sink 140, the pressure in the region around the pins drops. The low pressure creates air flow 260 through the perforations 230 formed in the pin assembly 120. The air flow 260 via the perforations is substantially parallel to the longitudinal direction of the ionizing electrode pins. Hence, despite the large number of ionizing electrode pins, the air flow 260 encounters minimal resistance from the ionizing electrode pins.

The unimpeded flow of air through the perforations 230 is advantageous, among other reasons, because neutral air particles are provided to the ionizing electrode pins at a high rate. As more neutral air particles become available to the pins, more air particles can be ionized at a faster rate, increasing the overall strength of the ionic wind. Further, the perforations 230 also prevent air pressure within the ionic wind generator 100 from dropping significantly. A significant drop in the air pressure within the ionic wind generator 100 may increase the chance of sparks occurring between the pin assembly 120 and the ion lens 130. By preventing the drop in air pressure, a higher voltage difference can be applied between the ionizing electrode pins and the ion lens 130.

In the embodiment of FIG. 2, the metal mesh 110 covers at least the pin assembly 120, the ion lens 130 and the heat sink 140. The metal mesh 110 is connected to ground via resistor R2 to neutralize any ionized air particles that come in contact.

The heat sink 140 is also connected to ground via resistor R1 to attract positively charged ionized air particles. The semiconductor chip 150 is electrically insulated (but not thermally insulated) from the heat sink 140 by a layer 210 of thermal compound. It is preferable not to connect the heat sink 140 to logic ground of the semiconductor chip 150 or related circuitry to prevent high frequency noise generated in the ionic wing generator 100 from affecting the operation of the electronic device. Instead, the heat sink 140 may be connected to ground of a system functioning as the positive voltage source and/or the negative voltage source.

In one embodiment, distance H1 between the pin assembly 120 and the ion lens 130 is between 10 to 15 mm. Further, distance H2 between the heat sink 140 and the ion lens 130 is also 10 to 15 mm. Distances H1 and H2 may be adjusted based on various factors such as the voltage level of the positive voltage source, current in the pin assembly 120, the voltage level of the negative voltage source, current in ion lens 130 and design restrictions on the overall height of the ionic wind generator 100.

In one embodiment, current in the pin assembly 120 received from the positive voltage source is approximately 1 mA or less. The current in the ion lens 130 to the negative voltage source is also approximately 1 mA or less.

FIG. 3A is a plan view of a pin assembly 120 in the ionic wind generator 100, according to one embodiment. The pin assembly 120 includes a large number of perforations 230 (shown as black dots) for passing air and holes 240 (shown as white dots) for receiving the ionizing electrode pins. In one embodiment, the holes and perforations are formed in an alternating manner on a substrate 330. The pins are inserted into the holes 240 and soldered to form connection to the positive voltage source. The conductive metal in the holes 240 is connected with each other, and hence, all the pins start to ionize air particles simultaneously.

The arrangement of perforations 230 and holes 240 in the substrate 330 in FIG. 3A is merely illustrative. If ionization of more air particles is critical to increasing the air flow, the number of holes 240 and ionizing electrode pins may be increased. In contrast, if providing sufficient supply of air to the ionizing electrode pins or preventing decrease in air pressure within the ionic wind generator 100 is more critical, the number of holes 240 may be reduced and the number of perforations 230 may be increased.

The holes and perforations need not be aligned in a straight line. For example, the holes and perforations may be arranged concentrically in circles or in random patterns. Further, the size of the holes 240 may be increased to prevent dust or other contaminants from blocking the air flow. The holes and perforations need not be circular. For example, the holes and perforations may have rectangular, elliptic or triangular shapes.

FIG. 3B is a sectional view of the pin assembly 120 in FIG. 3A taken along line A-A′, according to one embodiment. In one embodiment, distance Dp between the ionizing electrode pins is in the range of several millimeters or less depending on the diameter of the ionizing electrode pins.

FIG. 3C is a diagram illustrating an ionizing electrode pin 340 of the pin assembly 120 of FIG. 3A, according to one embodiment. The length of the pin 340 is L₁ and the diameter of the pin 340 is D. The pin 340 has a body 342 of a cylindrical shape that is secured to a hole 240, and an edge 342 of a conical shape for ionizing the air particles. More air particles tend to be generated as the length L₂ of the edge 342 increases. However, the length L₂ is limited by manufacturing constraints.

The ionizing electrode pin 340 is formed of material that does not oxidize but possesses good ionization characteristics. In one embodiment, the ionizing electrode pin 340 is formed of one of the following materials: tungsten, rhodium, titanium, ceramic-stainless alloy, platinum or heat treated stainless steel. The heat treated stainless steel includes SUS 316 that is heat treated at 700 to 800° C. for three or more hours in a vacuum condition. In one embodiment, the ionizing electrode pin 340 is formed of heat treated stainless steel and plated with tungsten, rhodium, titanium or platinum.

If the ionizing electrode pin 340 is formed of tungsten or plated with tungsten, it may be difficult to solder the ionizing electrode pin 340 to the holes 240. Hence, the body 342 of the ionizing electrode pin 340 may be plated with nickel or tin to facilitate soldering of the ionizing electrode pin 340 to a hole 240 of the substrate 330.

The perforations 230 are merely an example mechanism for providing an air flow into the ionic wind generator 100. Various other mechanisms may be employed to provide an air flow into the ionic wind generator 100. For example, longitudinal through-holes may be formed in the pins to function as a passage for the air. The passage formed in the pin 340 may replace the perforations 230 or supplant the perforations 230 to provide more air for ionization.

FIG. 4A is a plan view of an ion lens 130 in the ionic wind generator 100 of FIG. 4, according to one embodiment. The ion lens 130 is comprised of a conductive frame 410 and wires 420, 430. The wires 420, 430 are wound in parallel around the conductive frame 440 and/or are spot welded to the to the conductive frame 440. The wires 420, 430 are connected to the negative voltage source via the conductive frame 440. In one embodiment, the wires 420, 430 are made of tungsten, and the conductive frame 410 is made of copper. Using the tungsten wire is advantageous because, among other reasons, the tungsten wire is less susceptible to oxidization and has a high melting point about 3400. Hence, even if a spark is generated between the tungsten wire and the ionizing electrode pin, the tungsten can withstand the spark without melting. In another embodiment, the wires are made of nickel and frame 410 is made of a printed circuit board (PCB) having conductive pathways between the wires and the negative voltage source.

The conductive frame 410 has through-holes 440 formed at its four corners for receiving the spacers 134. A cavity 450 is formed in the frame through which the ionic wind passes. As the number of wires increase and the distance S between the wires decreases, the number of ionized air particles that collide with the wires 420, 430 and become neutralized will increase. In contrast, as the number of wires decreases and the distance S between the wires 420, 430 increases, weaker electric field will be formed. The weaker electric field will attract a fewer number of ionized air particles and result in weaker ionic wind. Hence, distance S between the wires and the number of wires 420, 430 may be adjusted to balance these two factors. In one embodiment, distance S is in the range of 4 to 6 mm.

FIG. 4B is a sectional view of the ion lens 130 of FIG. 4A taken along line B-B′, according to one embodiment. As illustrated in FIG. 4B, wires 420 (and also wires 430) are wound around the conductive frame 410. By providing two strands (i.e., 420A and 420B) of a wire across the cavity 450 of the conductive frame 410, stronger electric field is formed compared to when providing only a single strand across the cavity 450 of the conductive frame 410.

In one embodiment, slots (not shown) are formed on the conductive frame 410 to secure the wires 420, 430. Adhesives or other components may also be used to secure the wires to the conductive frame 410.

The shape and configuration of the ion lens 130 in FIG. 4A are merely illustrative. Frames of various other shapes (e.g., donut shaped or triangular) may also be used. Further, the wires need not be wound in parallel and may cross each other.

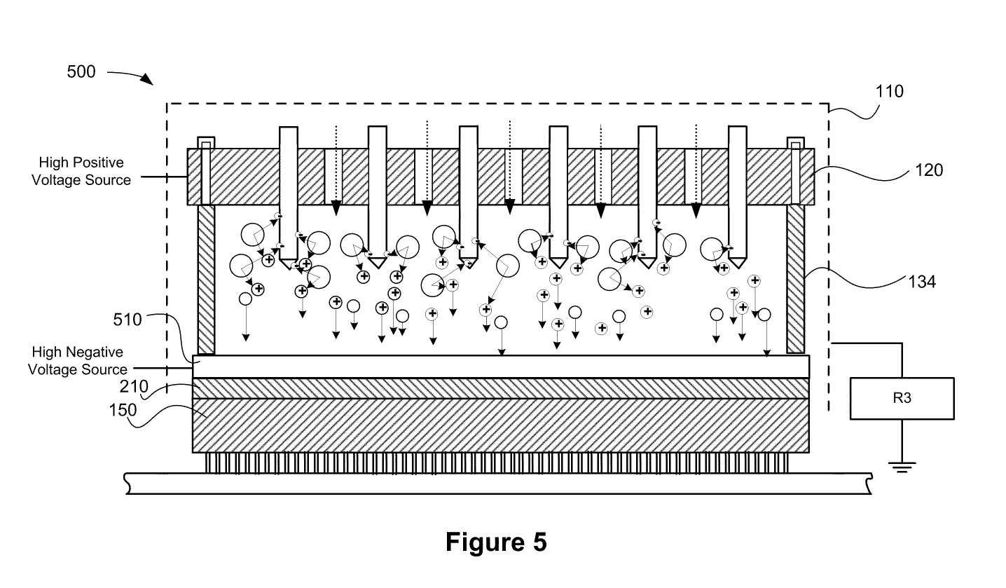

FIG. 5 is a sectional view of the ionic wind generator 500, according to another embodiment. In the embodiment of FIG. 5, the ionic wind generator 500 does not include an ion lens. Instead, a metal plate 510 (functioning as a collector electrode) is connected to a negative voltage source to attract and accelerate ionized air particles. The metal plate 510 is placed on the semiconductor 150 with a layer 210 of thermal compound between the metal plate 510 and the semiconductor 150. In this embodiment, a higher degree of electronic insulation between the metal plate 210 and the semiconductor chip 150 may be required because otherwise current caused by the negative voltage may damage the semiconductor chip 150. Configurations and functions of other components of the ionic wind generator 500 are the same as the embodiment of FIG. 2, and therefore, the description thereof is omitted for the sake of brevity.

Although above embodiments were described primarily with reference to using the ionic wind generator to cool a semiconductor chip, the ionic wind generator may be used in various other applications. For example, the ionic wind generator may be placed inside or outside various electronic devices to cool the heat generated by electronic components in the electronic devices. The ionic wind generator may also be a part of a heat pump system that cools an enclosed area or facility.

### Experiment Result of Ionic Wind Generator

An ionic wind generator according to an embodiment was placed in a desktop computer on top of a Pentium-4 processor operating at 1.7 Ghz. The width and depth dimension of the wind generator was approximately 100 mm and 100 mm, respectively. The pin assembly included 181 pins each having a length of 3.5 mm, to which a positive voltage of 8 kV was applied. Distance between the ion lens and the pin assembly was 11.5 mm. The pins were made of tungsten. The negative voltage applied to the ion lens was 1 kV to 1.5 kV.

The ionic wind generator provided sufficient cooling that obviated the need for a mechanical fan. The temperature of the processor was maintained around 53° C. with minor variations due to differing computational load conditions. The test was performed over 1,000 hours. A small amount of dust accumulation on the surfaces of the pins was observed but the ionizing electrode pins themselves did not show any signs of oxidation or other degradation.

In another experiment, two ionic wind generators were placed on a radio frequency (RF) amplifier (model no. STA2100-45MM-F4A-60T) for mobile base station manufactured by Sewon Teletech. The RF amplifier was operated at a half load condition. The recorded power consumption of the RF amplifier was 5A at 27 DC Voltage. Each ionic wind generator had the same configuration as the first experiment. Without the operation of the ionic wind generators, the RF amplifier was shutdown less than an hour due to overheating. When the ionic wind generators were activated, the RF amplifier operated without thermal shutdown for over two hours at which time the experiment was finished because no significant rise in temperature was observed.

### Method of Dissipating Heat Using Ionic Wind Generator

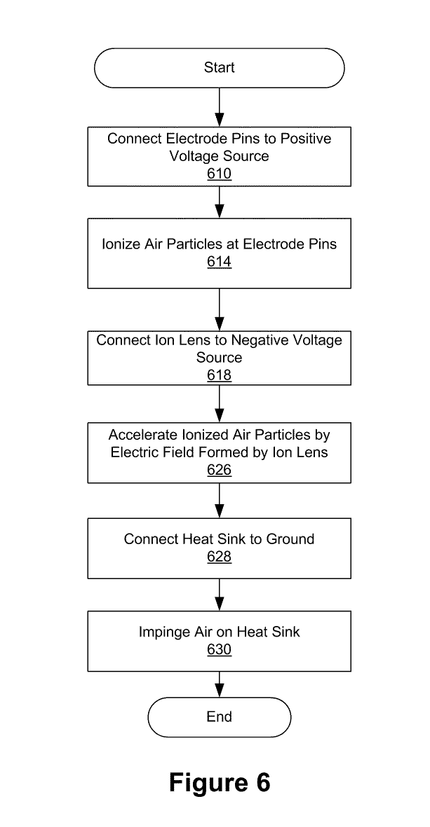

FIG. 6 is a flowchart illustrating a process of cooling a heat sink or a target device using the ionic wind, according to one embodiment. The ionizing electrode pins 340 of the pin assembly 120 are connected 610 to a positive voltage source. In response, the ionizing electrode pins 340 ionize 614 air particles by stripping the air particles of electrons.

Also, the ion lens is connected 618 to a negative voltage source. Responsive to connecting the ion lens to the negative voltage source, the air particles ionized by the pins 340 are accelerated 626 towards a heat sink or target device by the electric field created by the ion lens.

The heat sink is connected 628 to ground to attract more ionized air particles. The ionized air particles also drag neutral air particles around the ionized air particles and impinge 630 on the heat sink or the target device. As a result, heat is transferred from the heat sink or the target device to impinging air flow and cools the heat sink or the target device.

Some processes in FIG. 6 may be omitted. For example, in an ionic wind generator without an ion lens, steps 618 and 626 may be omitted. Further, the steps in FIG. 6 need not be performed in this order. For example, step 628 of connecting heat sink to ground may be performed before connecting 618 ion lens to the negative voltage source.

The foregoing embodiments of the invention have been presented for purposes of illustration and description only. They are not intended to be exhaustive or to limit the invention to the forms disclosed. Accordingly, the scope of the invention is defined by the appended claims, not the preceding disclosure.

What is claimed is:

1. An ionized wind generator, comprising:
an electrode assembly including a plurality of ionizing electrodes for ionizing air particles by coupling to a first voltage source, passages formed in the electrode assembly for directing air flow into the ionized wind generator; and
a collector electrode placed away from the electrode assembly, the collector electrode for receiving heat from a heat source, the collector electrode configured to attract the ionized air particles to impinge on the collector electrode by coupling to a second voltage source having a voltage level lower than the first voltage source.

2. The ionized wind generator of claim 1, wherein the electrode assembly comprises a substrate having a plurality of perforations functioning as the passages, the plurality of ionizing electrodes secured to the substrate, wherein at least a subset of the plurality of ionizing electrodes located adjacent to a subset of the plurality of perforations.

3. The ionized wind generator of claim 2, wherein air flows into the ionized wind generator via the perforations, wherein the perforations are configured to direct the air flow in a direction substantially parallel to lengths of the ionizing electrodes.

4. The ionized wind generator of claim 1, further comprising:
an ion lens placed between the electrode assembly and the collector electrode, the ion lens coupled to a third voltage source having a voltage level lower than the first voltage source and the second voltage source, the ion lens generating an electric field relative to the electrode assembly to accelerate the ionized air particles towards the collector electrode.

5. The ionized wind generator of claim 4, wherein the ion lens comprises a frame and a plurality of wires wound around the frame and welded to the frame, the ionized air particles passing through a cavity of the frame.

6. The ionized wind generator of claim 5, wherein the plurality of wires are formed of tungsten, and wherein the frame is formed of copper, nickel or printed circuit board.

7. The ionized wind generator of claim 1, wherein the plurality of ionizing electrodes are formed of a material selected from the group consisting of platinum, rhodium, tungsten and stainless steel.

8. The ionized wind generator of claim 1, wherein the plurality of ionizing electrodes are formed of stainless steel and plated with tungsten.

9. The ionized wind generator of claim 8, wherein the plurality of ionizing electrodes are inserted into a plurality of holes formed on a substrate, the plurality of ionizing electrodes at least partially plated with nickel to facilitate soldering of the plurality of ionizing electrodes to the substrate.

10. The ionized wind generator of claim 1, wherein the collector electrode is located over the heat source, and the electrode assembly is located over the collector electrode.

11. The ionized wind generator of claim 10, wherein the electrode assembly is supported by at least one non-conductive element secured to the collector electrode.

12. A method of operating an ionic wind generator, comprising:
supplying air cooler than a heat source to a plurality of ionizing electrodes via passages formed in the ionic wind generator for directing air flow into the ionized wind generator;
ionizing air particles by the plurality of ionizing electrodes responsive to coupling the plurality of ionizing electrodes to a first voltage source;
directing the ionized air particles to a collector electrode responsive to coupling the collector electrode to a second voltage source having a voltage level lower than the first voltage source, the collector electrode receiving heat from the heat source; and
cooling the collector electrode by exposing the collector electrode to the ionized air particles.

13. The method of claim 12, wherein a plurality of perforations functioning as the passages are formed in the substrate, at least a subset of the plurality of ionizing electrodes located adjacent to a subset of the plurality of perforations.

14. The method of claim 13, wherein the perforations are configured to direct the air in a direction substantially parallel to lengths of the ionizing electrodes.

15. The method of claim 12, further comprising:
accelerating the ionized air particles towards the collector electrode by coupling an ion lens to a third voltage source having a voltage level lower than the first voltage source and the second voltage source, the ionized lens placed between the electrode assembly and the collector electrode.

16. The method of claim 15, further comprising passing the ionized air particles through a cavity of the ion lens.

17. The method of claim 16, wherein the ion lens comprises a frame and a plurality of wires formed of tungsten, the frame formed of copper, nickel or a printed circuit board, the plurality of wires spot welded to the frame.

18. The method of claim 12, wherein the plurality of ionizing electrodes are formed of a material selected from the group consisting of platinum, rhodium, tungsten and stainless steel.

19. The method of claim 12, wherein the plurality of ionizing electrodes are formed of stainless steel and plated with tungsten.

20. The method of claim 19, wherein the plurality of ionizing electrodes are inserted into a plurality of holes formed on the substrate, the plurality of ionizing electrodes at least partially plated with nickel to facilitate soldering of the plurality of ionizing electrodes to the substrate.
